(19) United States
(12) Patent Application Publication
(10) Pub. No.: US 2021/0038465 A1
(43) Pub. Date: Feb. 11, 2021

(54) SYSTEMS AND METHODS FOR VESTIBULAR REHABILITATION

(71) Applicants: Southern Research Institute, Birmingham, AL (US); The UAB Research Foundation, Birmingham, AL (US)

(72) Inventor: Jennifer Christy, Birmingham, AL (US)

(21) Appl. No.: 16/070,342

(22) PCT Filed: Jan. 20, 2017
(86) PCT No.: PCT/US2017/014227

§ 371 Date: Jul. 16, 2018

Related U.S. Application Data
(60) Provisional application No. 62/281,861, filed on Jan. 22, 2016.

(51) Int. Cl. A61H 5/00; G09B 19/00

(52) U.S. Cl. CPC A61H 5/00; G09B 19/003; A61H 2201/1604; A61H 2201/5097; A61H 2201/5007; A61H 2201/5043; A61H 2201/5058; A61H 2201/165

(57) ABSTRACT

Systems and methods for controlling, conducting, and/or performing vestibular rehabilitation exercises. The individual performing a vestibular rehabilitation exercise progresses through the exercise by selecting target word or picture representations that are sequentially presented on a display. When read sequentially, the target word or picture representations form at least a portion of a phrase, a sentence, or a visual message. In use, a given exercise can correspond to the selection of a series of correct word or picture representations that correspond to the displayed target word or picture representations and form a book or story.

### CROSS-REFERENCE TO RELATED PATENT APPLICATION

This application claims priority to and the benefit of the filing date of U.S. Provisional Patent Application No. 62/281,861, filed Jan. 22, 2016, which is incorporated herein by reference in its entirety.

### BACKGROUND

The vestibular system is an exquisite sensory organ located in the inner ear that detects head movement and enables body balance, visual stability and perception of upright. Specifically, the vestibulo-ocular reflex (VOR) provides stability of vision during head movements at velocities greater than 100 degrees/second, which encompasses many daily activities. The peripheral vestibular system codes head movement into neural signals which are relayed to brainstem nuclei and then to cranial nerve nuclei to enable eye movements opposite of head movement. A dysfunctional VOR results in visual blurring during head movements, impacting the ability of an individual to see clearly during sports and reading activities. The peripheral vestibular labyrinth and VOR is known to be impaired in individuals (e.g., children) with profound sensorineural hearing loss, chronic otitis media, and congenital cytomegalovirus. Central vestibular neural pathways, also affecting visual stability, occur following concussion (Rine 2009). To treat gaze instability due to vestibular dysfunction, physical therapists prescribe dynamic compensation exercises to promote adaptation and substitution. The exercises should be completed daily, several times per day, to improve gaze stability. Adaptation exercises involve looking at a small letter and moving the head while focusing for up to 2 minutes. Substitution exercises involve producing quick eye movements, followed by quick head movements between 2 targets. Although adults can complete the exercises without difficulty, children do not complete the exercises since they are not functional, not fun, and do not provide feedback regarding performance (Herdman 1995, 1998, 2003, 2007). Preliminary studies confirm that children do respond favorably to vestibular rehabilitation, but they are unable to do the exercises independently (Braswell 2006). Studies also show that gaze stabilization exercises must be completed several times per day for up to 12 weeks for maximal benefit (Herdman 2007). Therefore, since children are unable to effectively complete the exercises at home, they so not improve gaze stability during head movement which affects reading and ability to play sports (Braswell 2006). Currently, the only way that children can effectively complete the exercises is in the presence of a therapist who can control head movement and optotype presentation.

Accordingly, there is a need in the art for improved systems and methods for performing vestibular rehabilitation exercises. In particular, there is a need in the art for systems and methods that facilitate the performance of vestibular rehabilitation exercises by children in remote locations (away from the therapists).

### SUMMARY

Disclosed herein, in one aspect, is a system having a display, an input assembly configured to receive at least one input of a user, a measurement assembly configured to monitor movement of the user and produce an output indicative of at least one characteristic of the movement of the user, and a processor communicatively coupled to the display, the input assembly, and the measurement assembly. In response to receipt of at least one output from the measurement assembly, the processor can be configured to confirm whether movement of the user is in accordance with at least one selected movement parameter. In response to movement of the user in accordance with the at least one selected movement parameter, the processor can be configured to present on the display a first arrangement of at least one word or picture representation. The first arrangement of at least one word or picture representation can comprise a first target word or picture representation. In response to receipt of an input indicative of the perception of the first target word or picture representation by the user, the processor can be configured to present on the display a second arrangement of at least one word or picture representation. The second arrangement of at least one word or picture representation can comprise a second target word or picture representation. When sequentially presented on the display, the first and second target word representations can form at least a portion of a phrase, sentence, or visual message.

In another aspect, disclosed herein is a system having a processor and one or more non-transitory machine-readable media storage modules to be executed by the processor. The modules can include a movement module configured to facilitate, by the processor, prompting movement of a user relative to the arrangements of at least one word or picture representation. The modules can also include a display module configured to facilitate, by the processor and in response to determining that the movement of the user is in accordance with at least one selected movement parameter, sequentially displaying a plurality of arrangements of at least one word or picture representations. The modules can further include a perception module configured to receive, by the processor, information regarding the user's perception of the at least one word or picture representation of each displayed arrangement. The modules can still further include a modification module configured to facilitate, by the processor and responsive to determination by the processor that the user has perceived a target word or picture representation of an arrangement, displaying the next sequential arrangement of the plurality of arrangements. When sequentially presented on the display, the target word or picture representations of the plurality of arrangements can form at least a portion of a phrase, a sentence, or a visual message.

In an additional aspect, disclosed herein is a method that includes producing, through a measurement assembly, at least one output indicative of at least one characteristic of movement of a user. The method can also include receiving, through a processor, at least one output of the measurement assembly. The method can also include determining, through the processor, whether movement of the user is in accordance with at least one selected movement parameter. In response to movement of the user in accordance with the at least one selected movement parameter, the processor can present on a display a first arrangement of at least one word or picture representation. The first arrangement of at least one word or picture representation can include a first target word or picture representation. The method can further include receiving, through the processor, at least one input indicative of the perception of the first arrangement of at least one word or picture representation by the user. The method can still further include determining, through the processor, whether an input of the at least one input is indicative of the first target word or picture representation. In response to receipt of an input indicative of the perception of the target word or picture representation by the user, the processor can present on the display a second arrangement of at least one word or picture representation. The second arrangement of at least one word or picture representation can include a second target word or picture representation. When sequentially presented on the display, the first and second target word representations form at least a portion of a phrase, a sentence, or a visual message.

Additional advantages of the disclosed system and method will be set forth in part in the description which follows, and in part will be understood from the description, or may be learned by practice of the disclosed system and method. The advantages of the disclosed system and method will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed system and method and together with the description, serve to explain the principles of the disclosed system and method.

FIGS. 1A-1F schematically depict the operation of an exemplary vestibular rehabilitation system as disclosed herein. FIG. 1A depicts a user holding a computing device (e.g., a phone or tablet) and wearing a measurement assembly that measures movement of the user's head. FIG. 1B depicts a user holding the computing device of FIG. 1A when the user's head is still. FIG. 1C depicts a user holding the computing device of FIG. 1B during movement of the user's head. FIG. 1D depicts a user observing and interacting with a computing device (e.g., a laptop computer) when the user's head is still. FIG. 1E depicts a user observing and interacting with the computing device of FIG. 1D during movement of the user's head. FIG. 1F depicts an exemplary sequential progression of word representations on a display of a computing device to form at least a portion of a phrase or sentence and, ultimately, a story.

FIG. 2 is a flowchart depicting an exemplary model for performing vestibular rehabilitation exercises as disclosed herein.

FIG. 3 is a diagram representing one exemplary configuration for a computing device as disclosed herein. As shown, the computing device can comprise a processor, an input assembly, and a display.

FIG. 4 is a diagram representing another exemplary configuration for a computing device as disclosed herein. As shown, the computing device can comprise a processor, an input assembly, a measurement assembly, and a display.

FIG. 5 is a schematic diagram of an exemplary operating environment for a computing device, which can include a processor as disclosed herein.

### DETAILED DESCRIPTION

The disclosed system and method may be understood more readily by reference to the following detailed description of particular embodiments and the examples included therein and to the Figures and their previous and following description.

### A. Definitions

It is to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural references unless the context clearly dictates otherwise. Thus, for example, reference to “a database” includes a plurality of such databases, and reference to “the database” is a reference to one or more databases and equivalents thereof known to those skilled in the art, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range¬ from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinence of the cited documents. It will be clearly understood that, although a number of publications are referred to herein, such reference does not constitute an admission that any of these documents forms part of the common general knowledge in the art.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

### B. Vestibular Rehabilitation Systems and Methods

Disclosed herein are vestibular rehabilitation systems and methods. It is contemplated that the disclosed systems and methods can empower children to perform dynamic compensation exercises while reading age appropriate stories or books of interest, thereby serving both a rehabilitative and educational purpose. Preliminary research has demonstrated that: (i) children with profound sensorineural hearing loss and vestibular hypofunction have abnormal ability to see with head movement; and (ii) children with vestibular dysfunction have difficulty reading small font sizes of print. Therefore, gaze instability not only affects the ability of children to see clearly while engaged in sports or other physical activities, but it can also affect their education.

Conventionally, patients complete adaptation exercises by turning their head side-to-side as if saying “no” or up-and-down as if saying “yes” while viewing a single letter written on a piece of paper. The patient is instructed to turn his or her head until the letter is “just about to go out of focus” for 1-2 minutes. Patients complete substitution exercises by moving their eyes, and then their head, to view two or more letters that are placed at a distance from each other on a wall. Although adults understand that the objective of these exercises is to improve gaze stability and decrease dizziness, children are not motivated and therefore do not keep their head moving since they cannot see the letter and are bored by the constant stimulus. Additionally, even when children attempt to complete these exercises, the children cannot be trusted to complete the exercises correctly. Consequently, children usually do not perform the gaze stabilization exercises properly and thus do not improve their gaze stability using the current methods.

Currently, standard adaptation and substitution exercises are performed manually using pieces of paper that display individual letters as viewing targets. Existing vestibular testing devices can measure head movement and track eye movement, but they do not provide exercises. Additionally, existing systems and methods for performing vestibular rehabilitation exercises are designed for use within a clinical setting. Typically, the patient wears a headband rate sensor and turns his or her head while identifying a letter generated by a computer interface. The therapist can manually advance the exercise when the patient gets the letter correct, thereby allowing the therapist to identify an appropriate size for the letter. The therapist then prints off a sheet having a letter of the correct size for the patient to use at home, and the headband rate sensor is returned to the clinician for use on other patients. Using these methods, once the patient leaves the clinic, the therapist has no way of knowing: (i) speed of head movement; (ii) compliance with the exercise; or (iii) success of the patient viewing the letter(s).

It is contemplated that the systems and methods disclosed herein can provide vestibular rehabilitation exercises that will be motivating and fun for children who are unable to complete adaptation and substitution exercises using traditional methods. Specifically, it is contemplated that the disclosed systems and methods can enable daily in-home use so that the patient (e.g., child) can quickly advance through the exercises while also practicing his or her reading of age-appropriate stories or books of interest. Additionally, it is contemplated that the disclosed systems and methods can provide dynamic (e.g., real-time, responsive) feedback to the patient to ensure compliance with exercise parameters that are defined by a therapist or other clinician. It is further contemplated that the disclosed systems and methods can also allow both the patient (e.g., child) and therapist to track activity and success with the exercises. It is still further contemplated that the tracking of in-home performance by the therapist can allow the therapist to make an informed determination of any adjustments to the exercise parameters that are necessary to promote the progress of the patient. It is contemplated that the disclosed systems and methods can be used to perform any conventional vestibular rehabilitation exercise protocol, including those described in Herdman 2003 and Herdman 2007, each of which is incorporated herein by reference in its entirety.

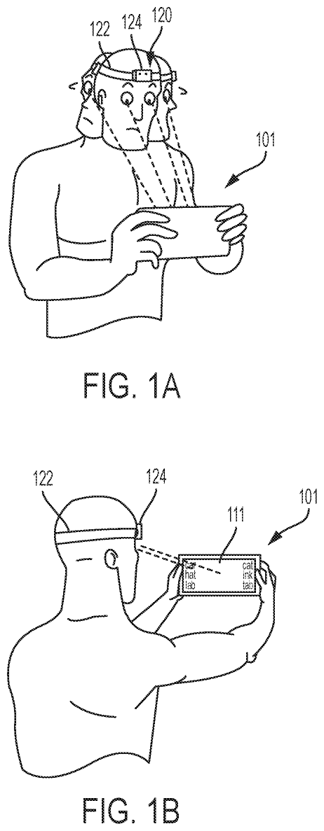

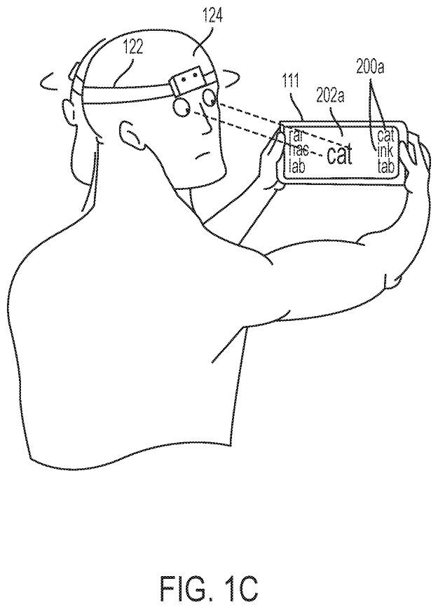

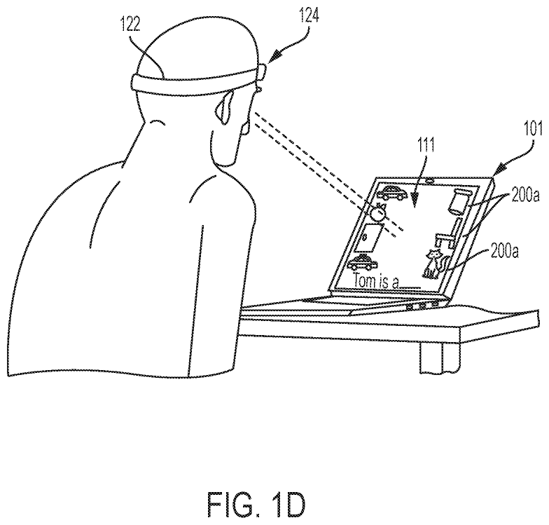

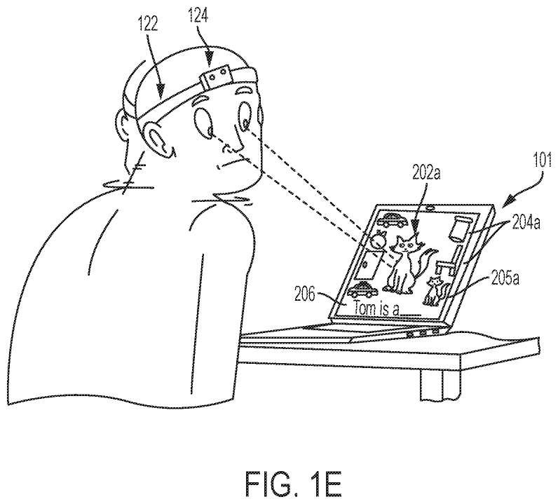

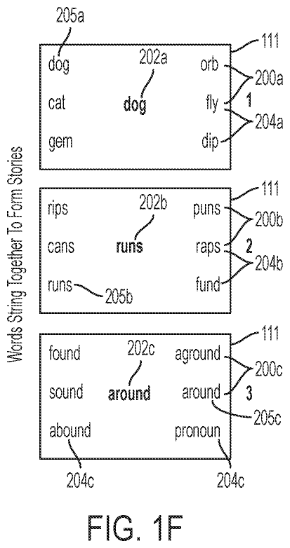

Disclosed herein with reference to FIGS. 1A-5 are systems and methods that, in exemplary aspects, can be used in vestibular rehabilitation. In various aspects, a system as disclosed herein can comprise a display 111, an input assembly (human-machine interface) 102, a measurement assembly 120, and a processor 103 communicatively coupled to the display, the input assembly, and the measurement assembly. In one aspect, the input assembly 102 can be configured to receive at least one input of a user. In another aspect, the measurement assembly 120 can be configured to monitor movement of the user and produce an output indicative of at least one characteristic of the movement of the user. In response to receipt of at least one output from the measurement assembly, the processor 103 can be configured to confirm whether movement of the user is in accordance with at least one selected movement parameter as further disclosed herein.

As shown in FIGS. 1B-1E, in response to movement of the user in accordance with the at least one selected movement parameter, the processor 103 can be configured to present on the display 111 a first arrangement of at least one word or picture representation 200a. As used herein, the term “word representation” can refer to a letter, a group of letters, a word, a phrase, a sentence, or combinations thereof, whereas the term “picture representation” can refer to a shape, a group of shapes, a symbol, a group of symbols, an image, a group of images, a drawing, a group of drawings, an animation, a group of animations, or combinations thereof. The first arrangement of at least one word or picture representation 200a can comprise a first target word or picture representation 202a. In response to receipt of an input indicative of the perception of the first target word or picture representation 202a by the user, the processor 103 can be configured to present on the display 111 a second arrangement of at least one word or picture representation 200b, which includes a second target word or picture representation 202b. Optionally, in exemplary aspects and as shown in FIGS. 1A-1E, the first arrangement of at least one word or picture representation 200a can further comprise a plurality of user-selectable word or picture representations, which can include at least one incorrect word or picture representation 204a that does not correspond to or match the first target word or picture representation 202a and a first correct word or picture representation 205a that corresponds to or matches the first target word or picture representation. In these aspects, it is contemplated that the input from the user can correspond to a selection of an incorrect word or picture representation 204a or a correct word or picture representation 205a, with the processor only being configured to present the second arrangement of at least one word or picture representation 200b when the correct word or picture representation 205a is selected. The second arrangement of at least one word or picture representation 200b can comprise a second target word or picture representation or picture 202b. In exemplary aspects, when sequentially presented on the display, the first and second target word representations 202a, 202b can form at least a portion of a phrase, a sentence, or a visual message. As this process is repeated and additional target word or picture representations are correctly identified, the sequence of correct word or picture representations can cooperate to form a story or message, which, in exemplary aspects, can comprise at least one sentence or at least one series of related symbols, images, drawings, or animations. For example, as shown in FIG. 1D, a third arrangement of at least one word or picture representation 200c can include a third target word representation 202c that expands upon the portion of the story or message formed by the first and second target word representations 202a, 202b. In another example, first, second, and third arrangements of at least one word or picture representation 200a, 200b, 200c can include first, second, and third target picture representations that cooperate to produce a message corresponding to the sequence of target picture representations. Thus, in contrast to conventional techniques that focus on a single letter, a user (e.g., a child) can actually read a story from a book of interest, or identify pictures (for example, if the child is unable to read). Optionally, in exemplary aspects, and as further disclosed herein, it is contemplated that the story or message produced by the sequence of target word or picture representations can include at least one word representation and at least one picture representation.

Optionally, it is contemplated that the display 111 can be configured to present additional information 206 that can assist the patient in identifying the correct word or picture representation while reinforcing reading skills. For example, in some exemplary aspects, and as shown in FIG. 1E, the additional information 206 can comprise a sequence of words or pictures that includes a blank where the target word or picture representation should be inserted. In these aspects, it is contemplated that the patient can refer to the additional information 206 to understand how the target word or picture representation is used in combination with other words or pictures.

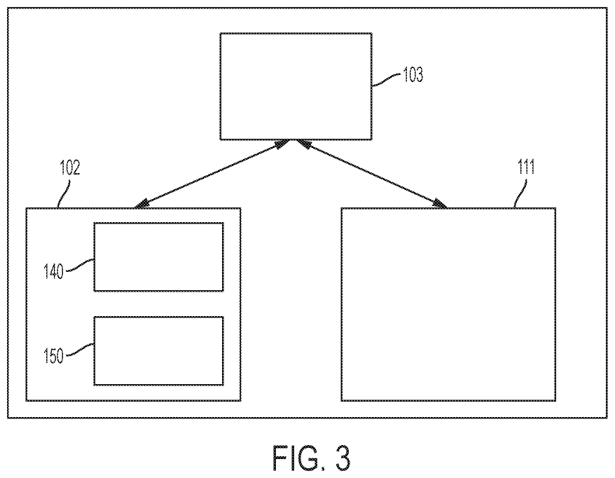

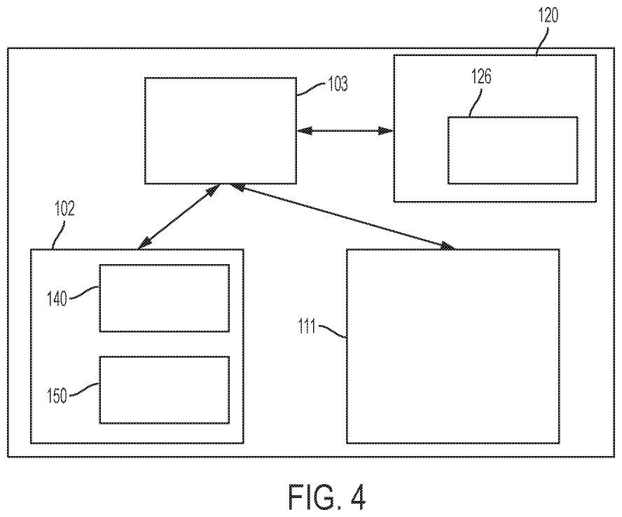

In one aspect, and with reference to FIGS. 3-4, the input assembly 102 can comprise a microphone 140 configured to receive a verbal input from the user. In this aspect, the processor 103 can be configured to determine whether the verbal input corresponds to a target word or picture representation (e.g., the first target word or picture representation 202a) presented on the display 111. Thus, it is contemplated that the processor 103 can operate conventional voice-recognition software to evaluate the verbal inputs received from the user. In use, it is contemplated that the disclosed system can improve the user's reading and oral communication skills while also achieving desired rehabilitation. In exemplary aspects, when the user provides a verbal input instead of a physical/mechanical input, it is contemplated that the plurality of user-selectable word or picture representations can be omitted from the display. Thus, in these aspects, each arrangement of at least one word or picture representation can comprise only the target word or picture representation.

In another aspect, and with reference to FIGS. 3-4, the input assembly 102 can comprise at least one input element 150 configured to receive a physical input from the user. In this aspect, the processor 103 can be configured to determine whether the physical input corresponds to a target word or picture representation (e.g., the first target word or picture representation 202a) presented on the display 111. In exemplary aspects, the at least one input element 150 can comprise at least one of a button, a switch, a joystick, a touchscreen portion of the display, a knob, and the like. Optionally, when a button is used as the at least one input element 150, it is contemplated that each button can be positioned in alignment with, or otherwise associated with, a corresponding user-selectable word or picture representation 200a, 200b, 200c. For example, at least one button can be aligned with a correct word or picture representation 205a, and at least one button can be aligned with an incorrect word or picture representation 204a to allow the user to make a selection among multiple choices. Optionally, when a switch, joystick, or knob is used as the at least one input element 150, it is contemplated that the at least one input element 150 can be used to selectively adjust a cursor or other selection tool on the display until reaching a word or picture representation on the display that the user intends to select. Optionally, when a touchscreen portion of a display is used as the at least one input element 150, it is contemplated that each input element 150 can correspond to an area of the display where a respective user-selectable word or picture representation 200a, 200b, 200c is located. For example, at least a portion of the touchscreen portion of the display can display (and be associated with) a correct word or picture representation 205a, and at least a portion of the touchscreen portion of the display can display (and be associated with) an incorrect word or picture representation 204a to allow the user to make a selection among multiple choices. In further exemplary aspects, it is contemplated that the input assembly 102 can comprise a microphone 140 as disclosed herein, in addition to the at least one input element 150. Thus, in these aspects, it is contemplated that the input assembly 102 can be configured to receive both verbal and physical inputs from the user.

Optionally, in exemplary aspects and with reference to FIGS. 1A-1E, the measurement assembly 120 can comprise a head band 122 and at least one sensor 124 coupled to the head band to monitor movement of the head of the user. In these aspects, it is contemplated that the head band can comprise a strap as is known in the art to permit size adjustment. It is further contemplated that the head band can comprise a casing and/or fastener for receiving and/or securing the at least one sensor 124 in an operative position relative to the head band 122. In one aspect, the at least one sensor 124 can comprise at least one motion sensor. Optionally, the at least one motion sensor can comprise at least one three-degrees-of-freedom (3DOF) motion sensor. In other exemplary aspects, the at least one motion sensor 124 can comprise an accelerometer. In exemplary aspects, it is contemplated that the at least one sensor 124 can be in communication with the processor 103 via a Bluetooth or other wireless connection. In additional aspects, the measurement assembly 120 can be configured to measure the duration of movement by the user. In these aspects, it is contemplated that the measurement assembly 120 can comprise a timer, a clock, or other conventional component that is capable of measuring time in response to an instruction from a processor. Thus, in use, it is contemplated that the system can record the amount of time that a user (e.g., child) spends doing exercises to provide for accountability and permit the therapist to monitor and evaluate compliance.

In exemplary aspects, and with reference to FIGS. 3-4, the display 111, the input assembly 102, and the processor 103 can all be components of a single computing device, such as, for example and without limitation, a smartphone, a tablet, a desktop or laptop computer, and the like. Optionally, in exemplary aspects and as shown in FIG. 4, it is contemplated that the measurement assembly 120 can also be provided as part of the computing device. For example, in these aspects, it is contemplated that the measurement assembly 120 can comprise a camera (e.g., video camera) 126 that is positioned in communication with the processor 103.

In various aspects, and as described further herein, each word or picture representation presented on the display can comprise at least one word or picture (i.e., either a single word or picture or a plurality of words or pictures). For example, each of the word or picture representations of the first and second arrangements of word representations can comprise at least one word or picture. In one aspect, the first correct word or picture representation can comprise a single word or picture. Alternatively, in another aspect, the first correct word or picture representation can comprise a plurality of words or pictures.

Optionally, in exemplary aspects, each arrangement of at least one word or picture representation can comprise a plurality of word or picture representations. In these aspects, the input assembly can be configured to permit the user to select the correct word or picture representation from among the plurality of user-selectable word or picture representations of each arrangement of at least one word or picture representation. For example, the first arrangement of at least one word or picture representation can comprise a first plurality of user-selectable word or picture representations, and the input assembly can be configured to permit the user to select the first correct word or picture representation from among the plurality of user-selectable word or picture representations of the first arrangement of at least one word or picture representation. Similarly, the second arrangement of at least one word or picture representation can comprise a second plurality of user-selectable word or picture representations, and the input assembly can be configured to permit the user to select the correct second word or picture representation from among the plurality of user-selectable word or picture representations of the second arrangement of at least one word or picture representation.

In operation, the processor can be configured to present on the display the second arrangement of at least one word or picture representation after confirming that movement of the user is in accordance with the at least one selected movement parameter. In exemplary aspects, the processor can be configured to sequentially present on the display additional arrangements of at least one word or picture representation in response to: (i) receipt of an input indicative of perception by the user of a correct word or picture representation of a previous arrangement of at least one word or picture representation; and (ii) receipt of at least one output from the measurement assembly corresponding to movement of the user in accordance with the at least one selected movement parameter. In further exemplary aspects, the processor can be configured to sequentially present additional arrangements on the display until a predetermined exercise sequence is completed. In these aspects, the exercise sequence can correspond to the formation of a complete story by the sequential display of the correct word or picture representations of the sequential arrangements of at least one word or picture representation.

During use, in response to inputs received from the user, the processor can be configured to adjust one or more parameters of the word or picture representations. In exemplary aspects, the one or more parameters of the word or picture representations can comprise font size, time of appearance on the display, location (e.g., vertical position, horizontal position, or combinations thereof) on the display, complexity of background pattern (the pattern behind the word or picture representations), or combinations thereof.

Additionally or alternatively, in response to outputs received from the measurement assembly, the processor can be configured to adjust the at least one selected movement parameter. Generally, as the user progresses through a rehabilitation program, the therapist can periodically increase the intensity, difficulty, or duration of the exercises by providing inputs to the processor that modify the at least one selected movement parameter, thereby increasing the threshold parameters that must be achieved before the user can progress through an exercise protocol. In exemplary aspects, the at least one selected movement parameter can comprise direction of head movement (e.g., up, down, left, right, diagonal, or combinations thereof such as left-right-left), speed of head movement, frequency of head movement, acceleration of head, duration of movement, or combinations thereof. Optionally, in exemplary aspects, the at least one selected movement parameter can comprise a plurality of selected movement parameters. For example, in some aspects, it is contemplated that the at least one selected movement parameter can comprise duration of movement in combination with at least one other movement parameter. In these aspects, it is contemplated that the processor can be configured to require the user to perform a particular exercise (in accordance with at least one movement parameter, such as moving the head) for a predetermined amount of time (selected by the therapist) that is appropriate for the user before an initial or sequential arrangement of word or picture representations is displayed. Thus, in use, the processor can ensure that the user correctly executes every individual exercise for a sufficient amount of time before the user is allowed to progress to the next exercise. It is further contemplated that the processor can be configured to require a user to repeat at least one exercise or stage of an exercise protocol if the user fails to correctly perform the exercise for a sufficient amount of time (as determined by the therapist and provided as an input to the processor). This capability is particular useful for children, who cannot be trusted to correctly complete exercises.

In exemplary aspects, the processor can be configured to assign a point value (e.g., a score) to each input that is indicative of perception by the user of a target word or picture representation. In these aspects, it is contemplated that the processor can be configured to determine a point total (e.g., a total score) corresponding to the total point value of all inputs that were indicative of perception by the user of a target word or picture representation. In further aspects, upon completion of the exercise sequence, the processor can be configured to present on the display a visual representation of the total point value. Thus, it is contemplated that the disclosed system can provide immediate and summary feedback to the user regarding performance.

In further exemplary aspects, the system can further comprise a memory that is communicatively coupled to the processor. In these aspects, it is contemplated that the memory can store a plurality of system performance parameters that are selectively adjustable by the user in response to one or more inputs provided to the processor via the input assembly. For example, in one aspect, the plurality of system performance parameters can comprise a word or picture display profile corresponding to a respective exercise sequence and story (i.e., the sequence of word or picture representations associated with a given display profile will correspond to a particular story and exercise sequence). In another aspect, the plurality of system performance parameters can comprise a display theme, which can determine, for example and without limitation, the colors used to depict each element on the display (e.g., the word or picture representations), and the overall layout of the display, including the relative locations and spacing of word and picture representations. In an additional aspect, the plurality of system performance parameters can comprise a point calculation system, which can determine, for example and without limitation: (i) a point value associated with each correctly identified word or picture representation, each correctly completed exercise step or sequence, or combinations thereof (ii) a target point total; or (iii) a point deduction associated with each incorrectly identified word or picture representation, each incorrectly completed exercise step or sequence, or combinations thereof. In a further aspect, the plurality of system performance parameters can comprise an input type for indicating perception of a target word or picture representation. In this aspect, it is contemplated that the input type can be audible (i.e., through microphone) or mechanical/electrical, through a button or touchscreen interface as further disclosed herein. In exemplary aspects, the plurality of system performance parameters can comprise a number of incorrect responses (either consecutively or total) before the processor adjusts the movement and/or word or picture representation parameters to make identification of the correct word or picture representation easier. For example, if the selected number of incorrect responses is met, then the processor can be configured to reduce the complexity of the word or picture representations (e.g., use smaller words or more easily distinguishable pictures), reduce the number of word or picture representations to choose from, adjust the background pattern (if present) to reduce interference with perception of the target word or picture representation, reduce the amount, specificity, or intensity of movement required, or combinations thereof. In further exemplary aspects, the plurality of system performance parameters can comprise a number of correct responses (either consecutively or total) before the processor adjusts the movement and/or word or picture representation parameters to make identification of the correct word or picture representation more difficult. For example, if the selected number of correct responses is met, then the processor can be configured to increase the complexity of the word or picture representations (e.g., use larger words or less distinguishable pictures), increase the number of word or picture representations to choose from, adjust the background pattern (if present) to increase interference with perception of the target word or picture representation, increase the amount, specificity, or intensity of movement required, or combinations thereof.

Optionally, in exemplary aspects, the processor can be configured to transmit data to, or receive data from, a remote computing device, such as, for example and without limitation, a computer, a smartphone, a tablet, and the like. In these aspects, it is contemplated that the remote computing device can be accessible by a therapist or clinician to permit monitoring of the performance of a patient and to permit remote modification of one or more system performance parameters, one or more word or picture representation parameters, and/or one or more selected movement parameters. In exemplary aspects, the processor can store in the memory or otherwise provide information regarding the user's performance, including exercise duration, speed/frequency of movement, angular magnitudes of movement, word or picture selection success rate, and the like. Optionally, in these aspects, the processor can be configured to generate a report for the therapist or clinician in a text file or other easily readable format, which can optionally be stored in the memory.

In exemplary aspects, it is contemplated that the processor can permit user-adjustment of certain ones of the system performance parameters, the word or picture representation parameters, and the selected movement parameters while restricting user-adjustment of other parameters (and only allowing adjustment of those parameters by a therapist or clinician). For example, it is contemplated that the processor can permit user-adjustment of the type of story to be displayed, background display themes, the type of reward/point system, the setting of smartphone/tablet reminders regarding exercises to be performed, and a selection of input type (e.g., voice or button). It is further contemplated that the therapist can be permitted to adjust the required speed of head movement, the complexity of the background display, font size, amount of time for each word or picture appearance, total time of each exercise, the number of incorrect or correct responses before one or more other parameters are adjusted to make the identification of a target word or picture representation easier or harder, or combinations thereof. In exemplary aspects, it is contemplated that the processor can be configured to restrict access to selected parameter adjustment interfaces using conventional password-protection or identity-confirmation software. For example, in these aspects, it is contemplated that the therapist can be provided with a password, code, or key that must be entered to permit adjustment of the required speed of head movement, the complexity of the background display, font size, amount of time for each word or picture appearance, total time of each exercise, the number of incorrect or correct responses before one or more other parameters are adjusted to make the identification of a target word or picture representation easier or harder, or combinations thereof. More generally, the therapist can be required to provide identify verification before the processor will permit adjustment of the required speed of head movement, the complexity of the background display, font size, amount of time for each word or picture appearance, total time of each exercise, the number of incorrect or correct responses before one or more other parameters are adjusted to make the identification of a target word or picture representation easier or harder, or combinations thereof.

In exemplary aspects, a system can comprise a processor and one or more non-transitory machine-readable media storage modules to be executed by the processor. In these aspects, it is contemplated that the modules can comprise a movement module, a display module, a perception module, and a modification module. In one aspect, the movement module can be configured to facilitate, by the processor, prompting movement of a user relative to the arrangements of at least one word or picture representation. In another aspect, the display module can be configured to facilitate, by the processor and in response to determining that the movement of the user is in accordance with at least one selected movement parameter, sequentially displaying a plurality of arrangements of at least one word or picture representation. In an additional aspect, the perception module can be configured to receive, by the processor, information regarding the user's perception of the at least one word or picture representation of each displayed arrangement. In a further aspect, the modification module can be configured to facilitate, by the processor and responsive to determination by the processor that the user has perceived a correct word or picture representation of an arrangement, displaying the next sequential arrangement of the plurality of arrangements.

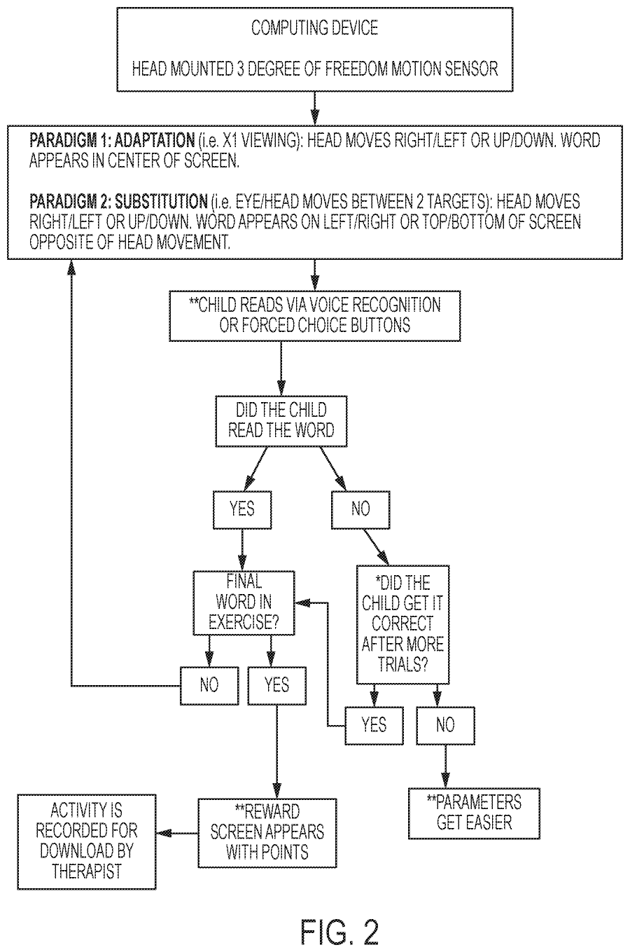

An exemplary method for performing a rehabilitation exercise using the disclosed system is schematically shown in FIG. 2. In exemplary aspects, a method of using the disclosed system can comprise producing, through the measurement assembly, at least one output indicative of at least one characteristic of movement of a user. In another aspect, the method can comprise receiving, through the processor, the at least one output of the measurement assembly. In a further aspect, the method can comprise determining, through the processor, whether movement of the user is in accordance with at least one selected movement parameter. In this aspect, in response to movement of the user in accordance with the at least one selected movement parameter, the processor can present on the display a first arrangement of at least one word or picture representation, and the first arrangement of at least one word or picture representation can comprise a first correct word or picture representation. In an additional aspect, the method can comprise receiving, through the processor, at least one input indicative of the perception of the first arrangement of at least one word or picture representation by the user. In still a further aspect, the method can comprise determining, through the processor, whether an input of the at least one input is indicative of the first correct word or picture representation. In this aspect, in response to receipt of an input indicative of the perception of the correct word or picture representation by the user, the processor can present on the display a second arrangement of at least one word or picture representation, and the second arrangement of at least one word or picture representation can comprise a second correct word or picture representation. As further disclosed herein, when sequentially presented on the display, the first and second correct word or picture representations can form at least a portion of a phrase, a sentence, or a visual message.

Thus, it is contemplated that the disclosed systems and methods can provide an integrated therapy solution that appeals to children through incentives and controls built into the software. In contrast to conventional systems and methods, the disclosed systems and methods can maintain compliance with the therapy in children while also promoting education (e.g., reading and speaking with user-selected stories or pictures that are of interest to the child). It is contemplated that the interface disclosed herein can encourage compliance and provide real-time feedback to the user when the session performed well or is not being performed properly. Additionally, the systems and methods enable users to perform both adaptation and substitution exercises, while also advancing to more difficult levels without input from an adult or clinician and capturing and reporting activity and success rates.

An exemplary system can comprise a mid-range smartphone or tablet computer (or, alternatively, a laptop computer), a Bluetooth-enabled three degree-of-freedom (3DOF) head-mounted motion sensor, and application software as disclosed herein. Rotational motion can be measured by the head-mounted sensor, which can convey the live data to a smartphone or computer application over a serial Bluetooth connection. The application can receive this raw data and analyze it, determining the current speed/frequency and angular magnitude of the user's rotational head movements. The Bluetooth-enabled wireless 3DOF motion sensor can be powered by a rechargeable battery and include a casing and a strap. Optionally, the application can provide a visual output on the display (of the smartphone, tablet, or laptop computer) indicating whether the user's head movements are in accordance with the movement parameters established by the therapist, thereby allowing the user to track performance in real-time. For example, if the therapist has established a minimum acceptable rate of head movement (i.e., during shaking), then the display can include a visual output showing the current rate of head movement (and, optionally, a comparison of the current rate of head movement to the minimum acceptable rate of head movement). One example of such a comparison is a graphical scale or gauge, which can optionally change appearance (e.g., color or size) based upon whether the user's rate of movement is above or below the minimum acceptable rate of head movement. In exemplary aspects, provided the user's rate of head movement remains above the minimum acceptable rate, the application can be configured to sequentially display arrangements of word or picture representations as the user sequentially identifies the target word or picture representation within each arrangement. In these aspects, if the user's rate of head movement falls below the minimum acceptable rate, then the application can be configured to cease display of further arrangements of word or picture representations until the user increases the rate of movement above the minimum acceptable rate.

In use, the user can wear the rate sensor and hold a smartphone in a landscape orientation (see FIGS. 1A-1C) or view a laptop computer screen (see FIGS. 1D-1E) while turning his or her head. When the characteristics of the user's head movements are within the specified range, a target word is displayed in the center of the display for the user to view and identify. In one form of the application, the user can be presented with six words or pictures and asked to choose the correct word or picture that matches or corresponds to the target word. In another form of the application, the user reads the word out loud or speaks a word corresponding to the picture and voice recognition software determines whether or not the spoken word was correct. If correct, the next word in the story or picture in the sequence appears on the display. The application can monitor the activity and record the duration, speed/frequency, angular magnitudes, success rate, and other characteristics of the participant's performance as a simple list of values in a text file (CSV format), and generate a report for the therapist.

Initially, the physical therapist can prescribe appropriate parameters based on the child's evaluation and reading level. The parameters can include speed and excursion of head movement required, timing of optotype presentation, total time of the exercise, background complexity, and font size. The child can be asked to choose from a list of age appropriate books or stories of interest which can be loaded into the application.

It is contemplated that the disclosed systems and methods can have immediate clinical application, and can also have valuable research implications since researchers will be able to determine the effective dose of therapy for children with varying types of vestibular dysfunction. It is further contemplated that the disclosed systems and methods will enable a child with vestibular impairments to perform exercises that promote adaptation (i.e. a word or picture appears as the child moves the head as if saying yes or no) and substitution (i.e. the word will appear to the right, left, up or down in response to a quick head movement to the opposite direction).

As can be appreciated, disclosed herein are data structures used in, generated by, or generated from, the disclosed method. Data structures generally are any form of data, information, and/or objects collected, organized, stored, and/or embodied in a composition or medium. A dataset stored in electronic form, such as in RAM or on a storage disk, is a type of data structure.

The disclosed method, or any part thereof or preparation therefor, can be controlled, managed, or otherwise assisted by computer control. Such computer control can be accomplished by a computer controlled process or method, can use and/or generate data structures, and can use a computer program. Such computer control, computer controlled processes, data structures, and computer programs are contemplated and should be understood to be disclosed herein.

As will be appreciated by one skilled in the art, the disclosed system and method may take the form of an entirely hardware embodiment, an entirely software embodiment, or an embodiment combining software and hardware aspects. Furthermore, the system and method may take the form of a computer program product on a computer-readable storage medium having computer-readable program instructions (e.g., computer software) embodied in the storage medium. More particularly, the present system and method may take the form of web-implemented computer software. Any suitable computer-readable storage medium may be utilized including hard disks, CD-ROMs, optical storage devices, or magnetic storage devices.

Embodiments of the system and method are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

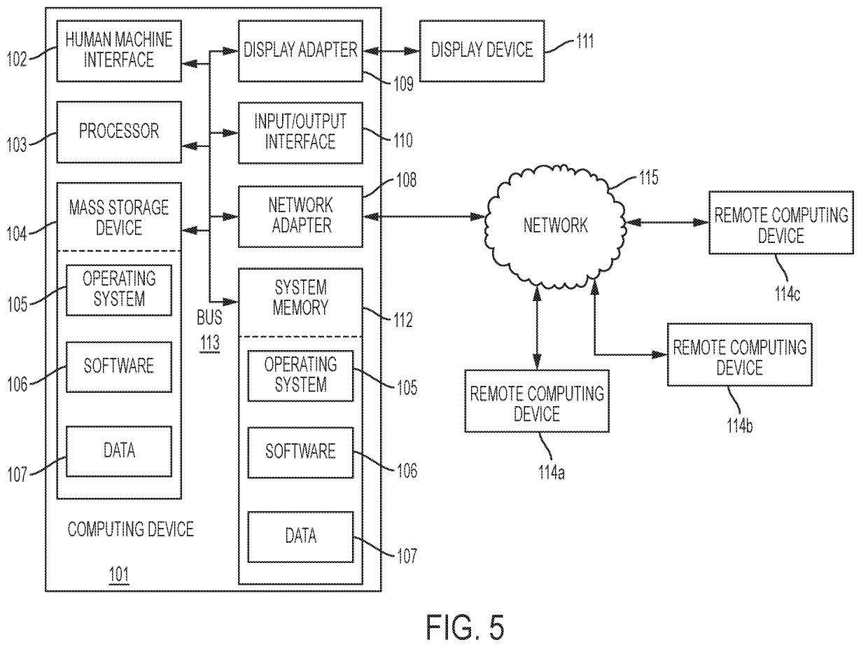

One skilled in the art will appreciate that provided herein is a functional description and that the respective functions can be performed by software, hardware, or a combination of software and hardware. In an exemplary aspect, the methods and systems can be implemented, at least in part, on a computing device 101 as illustrated in FIG. 5 and described below. By way of example, the processor 103 described herein can be part of a computing device 101 as illustrated in FIG. 5. Similarly, the methods and systems disclosed can utilize one or more computing devices (e.g., computers, smartphones, or tablets) to perform one or more functions in one or more locations.

FIG. 5 is a block diagram illustrating an exemplary operating environment for performing at least a portion of the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 101. The components of the computing device 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, control processing software 106, control processing data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computing device 101 typically comprises a variety of computer readable media. Exemplary readable media can be any available media that is accessible by the computing device 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as control processing data 107 and/or program modules such as operating system 105 and control processing software 106 that are immediately accessible to and/or are presently operated on by the processing unit 103.

In another aspect, the computing device 101 can also comprise other removable/non-removable, volatile/non-volatile computer storage media. By way of example, a mass storage device 104 can provide non-volatile storage of computer code, computer readable instructions, data structures, program modules, and other data for the computing device 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and control processing software 106. Each of the operating system 105 and control processing software 106 (or some combination thereof) can comprise elements of the programming and the control processing software 106. Control processing data 107 can also be stored on the mass storage device 104. Control processing data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 101 via an input device, such as input assembly 102 disclosed herein. Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface that is coupled to the system bus 113, but can be connected by other interface and bus structures, such as a parallel port, game port, an IEEE 1394 Port (also known as a Firewire port), a serial port, a universal serial bus (USB), or) or an Intel® Thunderbolt.

In yet another aspect, the display device 111 can also be connected to the system bus 113 via an interface, such as a display adapter 109. It is contemplated that the computing device 101 can have more than one display adapter 109 and the computing device 101 can have more than one display device 111. For example, a display device can be a monitor, an LCD (Liquid Crystal Display), an OLED (Organic Light Emitting Diode), or a projector. In addition to the display device 111, other output peripheral devices can comprise components such as speakers (not shown) and a printer (not shown) which can be connected to the computing device 101 via Input/Output Interface 110. Any step and/or result of the methods can be output in any form to an output device. Such output can be any form of visual representation, including, but not limited to, textual, graphical, animation, audio, tactile, and the like. The display 111 and computing device 101 can be part of one device, or separate devices.

The computing device 101 can operate in a networked environment using logical connections to one or more remote computing devices 114a,b,c. By way of example, a remote computing device can be a personal computer, portable computer, smartphone, a tablet, a server, a router, a network computer, a peer device or other common network node, and so on. In exemplary aspects, a remote computing device can be operated by a therapist as disclosed herein. Logical connections between the computing device 101 and a remote computing device 114a,b,c can be made via a network 115, such as a local area network (LAN) and/or a general wide area network (WAN). Such network connections can be through a network adapter 108. A network adapter 108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of control processing software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, solid state, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The above-described system components may be local to one of the devices (e.g., a computing device, such as a tablet or smartphone) or remote (e.g. servers in a remote data center, or “the cloud”). In exemplary aspects, it is contemplated that many of the system components can be provided in a “cloud” configuration.

### Exemplary Aspects

In view of the described devices, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A system, comprising: a display; an input assembly configured to receive at least one input of a user; a measurement assembly configured to monitor movement of the user and produce an output indicative of at least one characteristic of the movement of the user; a processor communicatively coupled to the display, the input assembly, and the measurement assembly, wherein, in response to receipt of at least one output from the measurement assembly, the processor is configured to confirm whether movement of the user is in accordance with at least one selected movement parameter, wherein, in response to movement of the user in accordance with the at least one selected movement parameter, the processor is configured to present on the display a first arrangement of at least one word or picture representation, wherein the first arrangement of at least one word or picture representation comprises a first target word or picture representation, wherein, in response to receipt of an input indicative of the perception of the first target word or picture representation by the user, the processor is configured to present on the display a second arrangement of at least one word or picture representation, wherein the second arrangement of at least one word or picture representation comprises a second target word or picture representation, and wherein, when sequentially presented on the display, the first and second target word or picture representations form at least a portion of a phrase, a sentence, or a visual message.

Aspect 2: The system of aspect 1, wherein the input assembly comprises a microphone configured to receive a verbal input from the user, and wherein the processor is configured to determine whether the verbal input corresponds to the first target word or picture representation presented on the display.

Aspect 3: The system of aspect 1 or aspect 2, wherein the input assembly comprises at least one input element configured to receive a physical input from the user, and wherein the processor is configured to determine whether the physical input corresponds to the first target word or picture representation presented on the display.

Aspect 4: The system of aspect 3, wherein the at least one input element of the input assembly comprises at least one button.

Aspect 5: The system of any one of the preceding aspects, wherein the measurement assembly comprises: a head band; and at least one sensor coupled to the head band to monitor movement of the head of the user.

Aspect 6: The system of aspect 5, wherein the at least one sensor comprises at least one motion sensor.

Aspect 7: The system of aspect 6, wherein the at least one motion sensor comprises at least one three-degrees-of-freedom (3DOF) motion sensor.

Aspect 8: The system of any one of the preceding aspects, wherein the display, the input assembly, and the processor are all components of a computing device.

Aspect 9: The system of aspect 8, wherein the computing device is selected from the group consisting of a smartphone, a tablet, and a computer.

Aspect 10: The system of any one of the preceding aspects, wherein each of the word or picture representations of the first and second arrangements of word or picture representations comprises at least one word or picture.

Aspect 11: The system of aspect 10, wherein the first target word or picture representation comprises a single word or picture.

Aspect 12: The system of aspect 10, wherein the first target word or picture representation comprises a plurality of words or pictures.

Aspect 13: The system of any one of the preceding aspects, wherein the first arrangement of at least one word or picture representation comprises a first plurality of user-selectable word or picture representations, wherein the first plurality of user-selectable word or picture representations comprises at least one incorrect word or picture representation and a first correct word or picture representation, and wherein the input assembly is configured to permit the user to select the first correct word or picture representation from among the first plurality of user-selectable word or picture representations.

Aspect 14: The system of aspect 13, wherein the second arrangement of at least one word or picture representation comprises a second plurality of user-selectable word or picture representations, wherein the second plurality of user-selectable word or picture representations comprises at least one incorrect word or picture representation and a second correct word or picture representation, and wherein the input assembly is configured to permit the user to select the second correct word or picture representation from among the second plurality of user-selectable word or picture representations.

Aspect 15: The system of any one of the preceding aspects, wherein the processor is configured to present on the display the second arrangement of at least one word or picture representation after confirming that movement of the user is in accordance with the at least one selected movement parameter.

Aspect 16: The system of aspect 15, wherein the processor is configured to sequentially present on the display additional arrangements of at least one word or picture representation in response to: receipt of an input indicative of perception by the user of a target word or picture representation of a previous arrangement of at least one word or picture representation; and receipt of at least one output from the measurement assembly corresponding to movement of the user in accordance with the at least one selected movement parameter.

Aspect 17: The system of aspect 16, wherein the processor is configured to sequentially present additional arrangements of at least one word or picture representation on the display until a predetermined exercise sequence is completed, and wherein the exercise sequence corresponds to the formation of a complete story by the sequential display of the correct word representations of the sequential arrangements of at least one word representation.

Aspect 18: The system of aspect 17, wherein, in response to inputs received from the user, the processor is configured to adjust one or more parameters of the word or picture representations.

Aspect 19: The system of aspect 18, wherein the one or more parameters comprise font size.

Aspect 20: The system of aspect 18 or aspect 19, wherein the one or more parameters comprise time of appearance on the display.

Aspect 21: The system of any one of aspects 18-20, wherein the one or more parameters comprise location on the display.

Aspect 22: The system of any one of aspects 17-21, wherein, in response to outputs received from the measurement assembly, the processor is configured to adjust the at least one selected movement parameter.

Aspect 23: The system of aspect 22, wherein the at least one selected movement parameter comprises direction of movement.

Aspect 24: The system of aspect 22 or aspect 23, wherein the at least one selected movement comprises speed of movement.

Aspect 25: The system of any one of the preceding aspects, wherein the measurement assembly is configured to measure the duration of movement by the user.

Aspect 26: The system of any one of aspects 17-25, wherein the processor is configured to assign a point value to each input that is indicative of perception by the user of a target word or picture representation, and wherein the processor is configured to determine a point total corresponding to the total point value of all inputs that were indicative of perception by the user of a target word or picture representation.

Aspect 27: The system of aspect 26, wherein, upon completion of the exercise sequence, the processor is configured to present on the display a visual representation of the total point value.

Aspect 28: The system of any one of the preceding aspects, further comprising a memory communicably coupled to the processor, wherein the memory stores a plurality of system performance parameters that are selectively adjustable by the user in response to one or more inputs provided to the processor via the input assembly.

Aspect 29: The system of aspect 28, wherein the plurality of system performance parameters comprises a word or picture display profile corresponding to a respective exercise sequence and story.

Aspect 30: The system of aspect 28 or aspect 29, wherein the plurality of system performance parameters comprises a display theme.

Aspect 31: The system of any one of aspects 28-30, wherein the plurality of system performance parameters comprises a point calculation system.

Aspect 32: The system of any one of aspects 28-31, wherein the plurality of system performance parameters comprises an input type for indicating perception of a target word or picture representation.

Aspect 33: The system of any one of the preceding aspects, wherein the processor is configured to transmit data to a remote computing device.

Aspect 34: A system, comprising: a processor; and one or more non-transitory machine-readable media storage modules to be executed by the processor, the modules comprising: a movement module configured to facilitate, by the processor, prompting movement of a user relative to the arrangements of at least one word or picture representation; a display module configured to facilitate, by the processor and in response to determining that the movement of the user is in accordance with at least one selected movement parameter, sequentially displaying a plurality of arrangements of at least one word or picture representation; a perception module configured to receive, by the processor, information regarding the user's perception of the at least one word or picture representation of each displayed arrangement; a modification module configured to facilitate, by the processor and responsive to determination by the processor that the user has perceived a target word or picture representation of an arrangement, displaying the next sequential arrangement of the plurality of arrangements, wherein, when sequentially presented on the display, the target word or picture representations of the plurality of arrangements form at least a portion of a phrase, a sentence, or a visual message.

Aspect 35: A method, comprising: producing, through a measurement assembly, at least one output indicative of at least one characteristic of movement of a user; receiving, through a processor, the at least one output of the measurement assembly; determining, through the processor, whether movement of the user is in accordance with at least one selected movement parameter, wherein, in response to movement of the user in accordance with the at least one selected movement parameter, the processor presents on a display a first arrangement of at least one word or picture representation, wherein the first arrangement of at least one word or picture representation comprises a first target word or picture representation, receiving, through the processor, at least one input indicative of the perception of the first arrangement of at least one word or picture representation by the user; determining, through the processor, whether an input of the at least one input is indicative of the first target word or picture representation, wherein, in response to receipt of an input indicative of the perception of the first target word or picture representation by the user, the processor presents on the display a second arrangement of at least one word or picture representation, wherein the second arrangement of at least one word or picture representation comprises a second target word or picture representation, and wherein, when sequentially presented on the display, the first and second target word or picture representations form at least a portion of a phrase, a sentence, or a visual message.

Those skilled in the art will recognize, or be able to ascertain using no more than routine experimentation, many equivalents to the specific embodiments of the method and compositions described herein. Such equivalents are intended to be encompassed by the following claims.

### REFERENCE LIST

1. Braswell J, Rine R M. Preliminary evidence of improved gaze stability following exercise in two children with vestibular hypofunction. Int J Pediatr Otorhinolaryngol 2006; 70(11):1967-1973.
2. Braswell J, Rine R M. Evidence that vestibular hypofunction affects reading acuity in children. Int J Pediatr Otorhinolaryngol 2006; 70(11):1957-1965.
3. Herdman S J, Clendaniel R A, Mattox D E, Holliday M J, Niparko J K. Vestibular adaptation exercises and recovery: acute stage after acoustic neuroma resection. Otolaryngology Head and Neck Surgery 1995; 113:77-87.
4. Herdman S J, Tusa R J, Blatt P, Suzuki A, Venuto P J, Roberts D. Computerized dynamic visual acuity test in the assessment of vestibular deficits. The American Journal of Otology 1998; 19:790-796.
5. Herdman S J, Schubert M C, Das V E, Tusa R J. Recovery of dynamic visual acuity in unilateral vestibular hypofunction. Otolaryngology Head and Neck Surgery 2003; 129:819-824.
6. Herdman S J, Hall C D, Schubert M C, Das V E, Tusa R J. Recovery of dynamic visual acuity in bilateral vestibular hypofunction
8. Arch Otolaryngol Head Neck Surg 2007; 133(4):383-389.
7. Rine R M. Growing evidence for balance and vestibular problems in children. Audiological Medicine 2009; 99999:1-5.

1. A system, comprising:
a display;
an input assembly configured to receive at least one input of a user;
a measurement assembly configured to monitor movement of the user and produce an output indicative of at least one characteristic of the movement of the user;
a processor communicatively coupled to the display, the input assembly, and the measurement assembly,
wherein, in response to receipt of at least one output from the measurement assembly, the processor is configured to confirm whether movement of the user is in accordance with at least one selected movement parameter,
wherein, in response to movement of the user in accordance with the at least one selected movement parameter, the processor is configured to present on the display a first arrangement of at least one word or picture representation, wherein the first arrangement of at least one word or picture representation comprises a first target word or picture representation,
wherein, in response to receipt of an input indicative of the perception of the first target word or picture representation by the user, the processor is configured to present on the display a second arrangement of at least one word or picture representation, wherein the second arrangement of at least one word or picture representation comprises a second target word or picture representation, and
wherein, when sequentially presented on the display, the first and second target word or picture representations form at least a portion of a phrase, a sentence, or a visual message.

2. The system of claim 1, wherein the input assembly comprises a microphone configured to receive a verbal input from the user, and wherein the processor is configured to determine whether the verbal input corresponds to the first target word or picture representation presented on the display.

3. The system of claim 1, wherein the input assembly comprises at least one input element configured to receive a physical input from the user, and wherein the processor is configured to determine whether the physical input corresponds to the first target word or picture representation presented on the display.

4. (canceled)

5. The system of claim 1, wherein the measurement assembly comprises:
a head band; and
at least one sensor coupled to the head band to monitor movement of the head of the user.

6. (canceled)

7. The system of claim 5, wherein the at least one sensor comprises at least one three-degrees-of-freedom (3DOF) motion sensor.

8. The system of claim 1, wherein the display, the input assembly, and the processor are all components of a computing device.

9. (canceled)

10. The system of claim 1, wherein each of the word or picture representations of the first and second arrangements of word or picture representations comprises at least one word or picture.

11. The system of claim 10, wherein the first target word or picture representation comprises a single word or picture.

12. The system of claim 10, wherein the first target word or picture representation comprises a plurality of words or pictures.

13. The system of claim 1, wherein the first arrangement of at least one word or picture representation comprises a first plurality of user-selectable word or picture representations, wherein the first plurality of user-selectable word or picture representations comprises at least one incorrect word or picture representation and a first correct word or picture representation, and wherein the input assembly is configured to permit the user to select the first correct word or picture representation from among the first plurality of user-selectable word or picture representations.

14. The system of claim 13, wherein the second arrangement of at least one word or picture representation comprises a second plurality of user-selectable word or picture representations, wherein the second plurality of user-selectable word or picture representations comprises at least one incorrect word or picture representation and a second correct word or picture representation, and wherein the input assembly is configured to permit the user to select the second correct word or picture representation from among the second plurality of user-selectable word or picture representations.

15. The system of claim 1, wherein the processor is configured to present on the display the second arrangement of at least one word or picture representation after confirming that movement of the user is in accordance with the at least one selected movement parameter.

16. The system of claim 15, wherein the processor is configured to sequentially present on the display additional arrangements of at least one word or picture representation in response to:
receipt of an input indicative of perception by the user of a target word or picture representation of a previous arrangement of at least one word or picture representation; and
receipt of at least one output from the measurement assembly corresponding to movement of the user in accordance with the at least one selected movement parameter.

17. The system of claim 16, wherein the processor is configured to sequentially present additional arrangements of at least one word or picture representation on the display until a predetermined exercise sequence is completed, and wherein the exercise sequence corresponds to the formation of a complete story by the sequential display of the correct word representations of the sequential arrangements of at least one word representation.

18. The system of claim 17, wherein, in response to inputs received from the user, the processor is configured to adjust one or more parameters of the word or picture representations.

19. (canceled)

20. (canceled)

21. (canceled)

22. The system of claim 17, wherein, in response to outputs received from the measurement assembly, the processor is configured to adjust the at least one selected movement parameter.

23. (canceled)

24. (canceled)

25. The system of claim 1, wherein the measurement assembly is configured to measure the duration of movement by the user.

26. The system of claim 17, wherein the processor is configured to assign a point value to each input that is indicative of perception by the user of a target word or picture representation, and wherein the processor is configured to determine a point total corresponding to the total point value of all inputs that were indicative of perception by the user of a target word or picture representation.

27. (canceled)

28. The system of claim 1, further comprising a memory communicably coupled to the processor, wherein the memory stores a plurality of system performance parameters that are selectively adjustable by the user in response to one or more inputs provided to the processor via the input assembly.

29. (canceled)

30. (canceled)

31. (canceled)

32. (canceled)

33. The system of claim 1, wherein the processor is configured to transmit data to a remote computing device.

34. A system, comprising:
a processor; and
one or more non-transitory machine-readable media storage modules to be executed by the processor, the modules comprising:
a movement module configured to facilitate, by the processor, prompting movement of a user relative to the arrangements of at least one word or picture representation;
a display module configured to facilitate, by the processor and in response to determining that the movement of the user is in accordance with at least one selected movement parameter, sequentially displaying a plurality of arrangements of at least one word or picture representation;
a perception module configured to receive, by the processor, information regarding the user's perception of the at least one word or picture representation of each displayed arrangement;
a modification module configured to facilitate, by the processor and responsive to determination by the processor that the user has perceived a target word or picture representation of an arrangement, displaying the next sequential arrangement of the plurality of arrangements,
wherein, when sequentially presented on the display, the target word or picture representations of the plurality of arrangements form at least a portion of a phrase, a sentence, or a visual message.

35. A method, comprising:
producing, through a measurement assembly, at least one output indicative of at least one characteristic of movement of a user;
receiving, through a processor, the at least one output of the measurement assembly;
determining, through the processor, whether movement of the user is in accordance with at least one selected movement parameter, wherein, in response to movement of the user in accordance with the at least one selected movement parameter, the processor presents on a display a first arrangement of at least one word or picture representation, wherein the first arrangement of at least one word or picture representation comprises a first target word or picture representation,
receiving, through the processor, at least one input indicative of the perception of the first arrangement of at least one word or picture representation by the user;
determining, through the processor, whether an input of the at least one input is indicative of the first target word or picture representation, wherein, in response to receipt of an input indicative of the perception of the first target word or picture representation by the user, the processor presents on the display a second arrangement of at least one word or picture representation, wherein the second arrangement of at least one word or picture representation comprises a second target word or picture representation, and
wherein, when sequentially presented on the display, the first and second target word or picture representations form at least a portion of a phrase, a sentence, or a visual message.
